(19) United States
(12) Patent Application Publication
(10) Pub. No.: US 2026/0240108 A1
(43) Pub. Date: Aug. 20, 2026

(54) PET BED

(71) Applicant: JIANGSU ZHONGHENG PET ARTICLES JOINT-STOCK CO., LTD., Jiangsu (CN)

(72) Inventor: Bin QIU, Jiangsu (CN)

(73) Assignee: JIANGSU ZHONGHENG PET ARTICLES JOINT-STOCK CO., LTD., Jiangsu (CN)

(21) Appl. No.: 19/423,897

(22) Filed: Dec. 17, 2025

(30) Foreign Application Priority Data
Feb. 17, 2025 (CN) 202520244205.8

(51) Int. Cl. A01K 1/035

(52) U.S. Cl. CPC A01K 1/0353

(57) ABSTRACT

A pet bed includes a bed board, a bed frame connected to a lower surface of the bed board, and a connection assembly connected to a bottom of the bed frame. The assembly of the bed frame may be completed by directly inserting the bottom of the bed frame into the connection assembly, and the bed frame may be disassembled by removing the connection assembly from the bottom of the bed frame.

### CROSS-REFERENCE TO RELATED APPLICATION

This application claims the priority benefit of China application serial no. 202520244205.8, filed on February 17, 2025. The entirety of the above-mentioned patent application is hereby incorporated by reference herein and made a part of this specification.

### BACKGROUND

### Technical Field

The present disclosure relates to the field of pet products, and specifically to a pet bed.

### Description of Related Art

With the improvement of living standards, more and more families are keeping pets such as cats and dogs to increase the fun of life. A pet bed is a bed for pets to sleep and relax.

In some existing pet beds, a bed frame is formed by metal tubes connected together, and a supporting pad is connected on the bed frame. However, the assembly of the bed frame requires using screws to connect the metal tubes, which is cumbersome.

### SUMMARY

To solve the technical problem that existing pet beds are cumbersome to assemble due to use of screws for connection, an objective of the present disclosure is to provide a pet bed.

To achieve the above objective, an embodiment of the present disclosure provides a pet bed, including:

a bed board;

a bed frame, where the bed frame is connected to a lower surface of the bed board; and

a connection assembly, where the connection assembly is connected to a bottom of the bed frame.

In the above technical solution, the bed frame includes:

two first U-shaped tubes, where the two first U-shaped tubes are respectively connected to a first pair of side edges of the bed board; and

two second U-shaped tubes, where the two second U-shaped tubes are respectively connected to a second pair of side edges of the bed board, and two ends of each of the two second U-shaped tubes are respectively in contact with end portions of the two first U-shaped tubes on an identical side to the each of the two second U-shaped tubes; or

the bed frame includes:

two first U-shaped tubes, where the two first U-shaped tubes are respectively connected to a pair of side edges of the bed board; and

at least two mounting tubes, where the at least two mounting tubes are arranged between the two first U-shaped tubes.

In the above technical solution, the connection assembly includes:

limiting members, where the limiting members are respectively arranged in two ends of each of the two first U-shaped tubes and penetrate each of the two first U-shaped tubes;

first sleeves, where the first sleeves are respectively sleeved over end portions of the two first U-shaped tubes, at least one through hole is provided on each of the first sleeves, and the at least one through hole is arranged opposite to a respective limiting member of the limiting members; and

second sleeves, where the second sleeves are respectively sleeved over end portions of the two second U-shaped tubes, and the second sleeves are respectively connected to the first sleeves; or

the connection assembly includes:

connection members, where the connection members are respectively connected to the two first U-shaped tubes and the two second U-shaped tubes; or

connection members, where the connection members are respectively connected to the two first U-shaped tubes and the at least two mounting tubes.

In the above technical solution, an upper end of each of the two first U-shaped tubes is even with an upper end of each of the two second U-shaped tubes.

In the above technical solution, a first connecting tube is connected to one of the two first U-shaped tubes, and the first connecting tube is even with an upper end of the other of the two first U-shaped tubes.

In the above technical solution, a second connecting tube is arranged above one of the at least two mounting tubes, and two ends of the second connecting tube are respectively connected to the two first U-shaped tubes.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure will become apparent and comprehensible from the description of embodiments made in connection with the accompanying drawings, in which:

FIG. 1 is a schematic structural diagram of a bed frame according to Embodiment 1 of the present disclosure.

FIG. 2 is an overall schematic structural diagram of Embodiment 2 of the present disclosure.

FIG. 3 is a schematic structural diagram of a bed frame according to Embodiment 2 of the present disclosure.

FIG. 4 is a schematic cross-sectional structural diagram of a first U-shaped tube according to the present disclosure.

FIG. 5 is a schematic structural enlarged view of part A of the present disclosure.

FIG. 6 is a schematic structural diagram of a bed frame according to Embodiment 3 of the present disclosure.

### DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

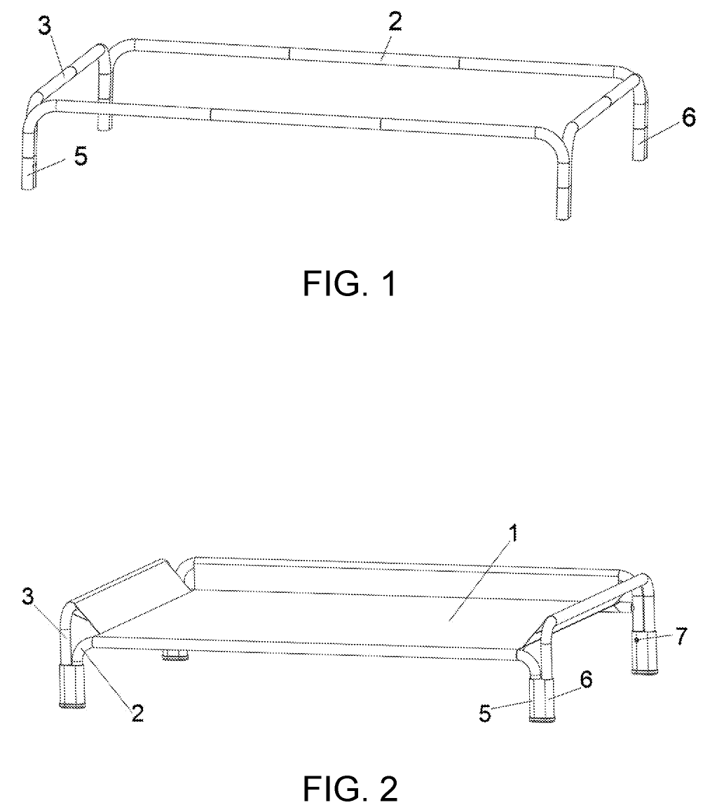

A pet bed according to some embodiments of the present disclosure will be described below with reference to FIG. 1 to FIG. 6.

As shown in FIG. 1 to FIG. 6, an embodiment of the present disclosure provides a pet bed, including a bed board 1, a bed frame, and a connection assembly.

Specifically, the bed board 1 is of a rectangular shape. The bed frame is fixedly connected to an edge of a lower surface of the bed board 1. The connection assembly is detachably connected to a bottom of the bed frame.

To assemble the pet bed, the bottom of the bed frame is inserted into the connection assembly to complete the connection of the bed frame. The assembly process is simple and convenient.

### Embodiment 1:

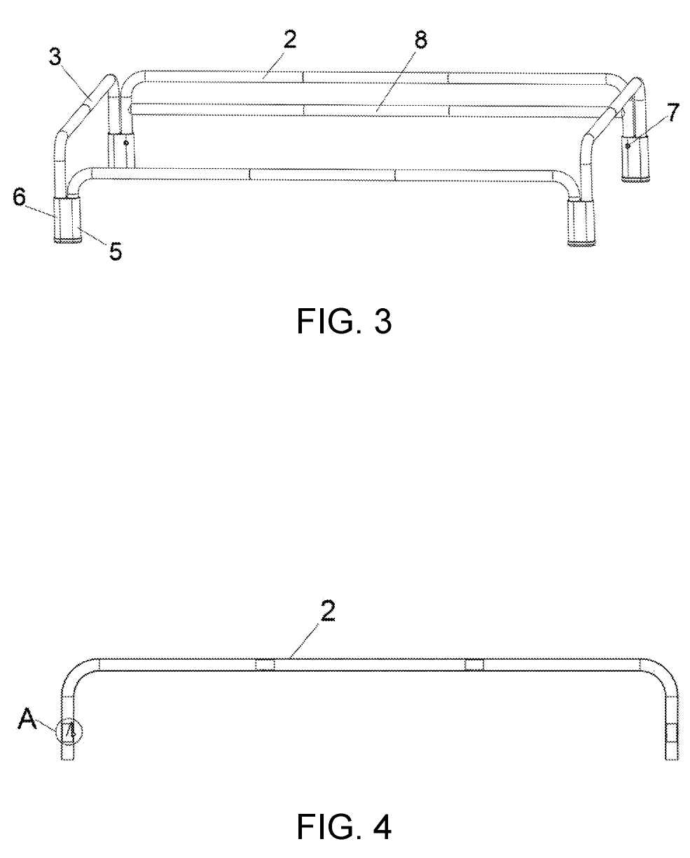

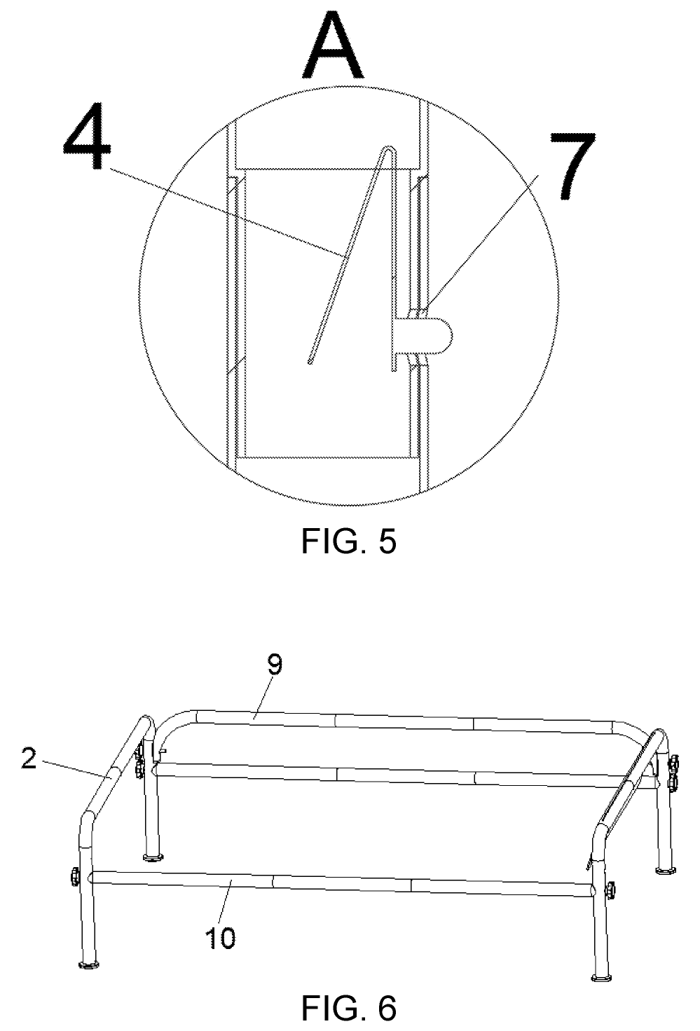

As shown in FIG. 1, FIG. 4, and FIG. 5, in an embodiment of the present disclosure, the bed frame includes two first U-shaped tubes 2 and two second U-shaped tubes 3.

The two first U-shaped tubes 2 are fixedly connected to a front side edge and a rear side edge of the bed board 1 respectively. An opening of each of the two first U-shaped tubes 2 faces downward. Each of the two first U-shaped tubes 2 includes a first horizontal tube and two first vertical tubes. The two first vertical tubes are fixedly connected to a left end and a right end of the first horizontal tube respectively. The two first vertical tubes are arranged below the first horizontal tube. The two first horizontal tubes of the two first U-shaped tubes 2 are respectively connected to the front side edge and the rear side edge of the bed board 1.

The two second U-shaped tubes 3 are fixedly connected to a left side edge and a right side edge of the bed board 1 respectively. An opening of each of the two second U-shaped tubes 3 faces downward. Each of the two second U-shaped tubes 3 includes a second horizontal tube and two second vertical tubes. The two second vertical tubes are fixedly connected to a front end and a rear end of the second horizontal tube respectively. The two second vertical tubes are arranged below the second horizontal tube. The two second horizontal tubes of the two second U-shaped tubes 3 are respectively connected to the left side edge and the right side edge of the bed board 1.

The two first vertical tubes on the left side are respectively in contact with the two second vertical tubes on the left side, and the two first vertical tubes on the right side are respectively in contact with the two second vertical tubes on the right side.

The connection assembly includes limiting members 4, first sleeves 5, and second sleeves 6.

The limiting members 4 are respectively arranged in the first vertical tubes of the two first U-shaped tubes 2. The limiting members 4 respectively penetrate the first vertical tubes. Each of the limiting members 4 includes a V-shaped elastic piece fixedly connected to an interior of the first vertical tube and a protrusion fixedly connected to the V-shaped elastic piece. The protrusion penetrates the first vertical tube.

Each of the first sleeves 5 is sleeved over a bottom of a respective one of the first vertical tubes in the two first U-shaped tubes 2. A through hole 7 is provided on each first sleeve 5. The through hole 7 is arranged opposite to a respective one of the limiting members 4.

Each of the second sleeves 6 is sleeved over a bottom of a respective one of the second vertical tubes in the two second U-shaped tubes 3. The second sleeves 6 are fixedly connected to the first sleeves 5 respectively.

To assemble the pet bed, the first sleeve 5 is sleeved over the bottom of the first vertical tube. Because the first vertical tube and the respective second vertical tube are connected together, the second sleeve 6 is also sleeved over the bottom of the second vertical tube while the first sleeve 5 is sleeved. During insertion of a lower end of the first vertical tube into the first sleeve 5, because the V-shaped elastic piece is arranged in the first vertical tube and the protrusion penetrates the first vertical tube and is arc-shaped, an upper end of the first sleeve 5 exerts pressure on the protrusion, causing the protrusion to compress the V-shaped elastic piece. Under a thrust force of the V-shaped elastic piece, the protrusion is always in contact with an inner wall of the first sleeve 5 during sliding of the first sleeve 5. When the protrusion moves to the through hole 7, the V-shaped elastic piece pushes the protrusion to pass through the through hole 7, thereby fixing the pet bed. The above assembly process only requires respectively sleeving the first sleeve 5 and the second sleeve 6 over the lower end of the first vertical tube and the lower end of the second vertical tube, and therefore is simple to operate and efficient.

It should be noted that the first vertical tube includes a #1 first vertical-tube segment and a #2 first vertical-tube segment. An upper end of the #1 first vertical-tube segment is connected to a lower end of the #2 first vertical-tube segment. The #1 first vertical-tube segment and the #2 first vertical-tube segment are integrally formed. An outer diameter of the #1 first vertical-tube segment is smaller than an outer diameter of the #2 first vertical-tube segment. The first sleeve 5 is sleeved over the #1 first vertical-tube segment. When the protrusion enters the through hole 7, the upper end of the first sleeve 5 comes into contact with the lower end of the #2 first vertical-tube segment, so that the first sleeve 5 is limited by the #2 first vertical-tube segment to prevent the protrusion from retracting into the first sleeve 5 due to the weight of a pet on the pet bed, thereby ensuring the effective connection between the first sleeve 5 and the #1 first vertical-tube segment.

The second vertical tube includes a #1 second vertical-tube segment and a #2 second vertical-tube segment. An upper end of the #1 second vertical-tube segment is connected to a lower end of the #2 second vertical-tube segment. The #1 second vertical-tube segment and the #2 second vertical-tube segment are integrally formed. An outer diameter of the #1 second vertical-tube segment is smaller than an outer diameter of the #2 second vertical-tube segment. The second sleeve 6 is sleeved over the #1 second vertical-tube segment. When the protrusion enters the through hole 7, an upper end of the second sleeve 6 comes into contact with the lower end of the #2 second vertical-tube segment, so that the second sleeve 6 is limited by the #2 second vertical-tube segment to prevent the protrusion from retracting into the first sleeve 5 due to the weight of a pet on the pet bed, thereby ensuring the effective connection between the second sleeve 6 and the #1 second vertical-tube segment.

The first U-shaped tube 2 and the second U-shaped tube 3 are connected by the first sleeve 5 and the second sleeve 6. A length of the #1 first vertical-tube segment may be less than a length of the first sleeve 5, and a length of the #1 second vertical-tube segment may be less than a length of the second sleeve 6, so that the manufacturing costs of the first vertical tube and the second vertical tube can be reduced.

As shown in FIG. 1, in an embodiment of the present disclosure, the first horizontal tubes in the two first U-shaped tubes 2 and the second horizontal tubes in the two second U-shaped tubes 3 are at the same height, and the first vertical tubes and the second vertical tubes have the same length.

The bed board 1 is made of a fabric. The bed board 1 is mounted on upper surfaces of the first horizontal tubes and the second horizontal tubes to form a flat surface for a pet to rest.

In addition, when the connection assembly includes connection members which are each a screw, the first vertical tubes on the left side and the second vertical tubes on the left side are respectively provided with threaded holes. The corresponding threaded holes are connected by using the screw, thereby respectively connecting the first vertical tubes on the left side to the second vertical tubes on the left side. The connection mode of the first vertical tubes on the right side and the second vertical tubes on the right side is the same as that of the first vertical tubes on the left side and the second vertical tubes on the left side, so the details will not be elaborated herein.

### Embodiment 2:

The connection mode of the two first U-shaped tubes 2 and the two second U-shaped tubes 3 in Embodiment 2 is the same as that in Embodiment 1, so the details will not be elaborated herein.

As shown in FIG. 2 to FIG. 5, in an embodiment of the present disclosure, a first connecting tube 8 is fixedly connected between the two first vertical tubes in one first U-shaped tube 2 of the two first U-shaped tubes 2, the first horizontal tube in the one first U-shaped tube 2 is even with the two second horizontal tubes in the two second U-shaped tubes 3, and the first connecting tube 8 is even with the first horizontal tube in the other of the two first U-shaped tubes 2.

The bed board 1 is made of a fabric. A rear end of the bed board 1 is mounted on the first connecting tube 8, and a front end of the bed board 1 is mounted on the first horizontal tube that is even with the first connecting tube 8, so that the bed board 1 forms a flat surface for a pet to rest. A left end, a right end, and a rear end of the bed board 1 are fixedly connected to first ends of three fences respectively. The three fences and the bed board 1 are integrally formed. Second ends of the three fences are fixedly connected to the second horizontal tube at the left end, the second horizontal tube at the right end, and the first horizontal tube at the rear end respectively. The fences can prevent a pet from falling off the bed board 1 during sleeping.

### Embodiment 3:

As shown in FIG. 6, in an embodiment of the present disclosure, the bed frame includes two first U-shaped tubes 2 and two mounting tubes 10.

An opening of each of the two first U-shaped tubes 2 faces downward. Each of the two first U-shaped tubes 2 includes a first horizontal tube and two first vertical tubes. The two first vertical tubes are fixedly connected to two ends of the first horizontal tube respectively. The two first vertical tubes are respectively a #1 first vertical tube and a #2 first vertical tube.

Two ends of one of the two mounting tubes 10 are respectively connected to the two #1 first vertical tubes by screws. Two ends of the other of the two mounting tubes 10 are respectively connected to the two #2 first vertical tubes by screws. In a vertical direction, the two mounting tubes 10 are at a height lower than the height of the first horizontal tubes. A second connecting tube 9 is arranged above one of the two mounting tubes 10. Two ends of the second connecting tube 9 are respectively connected to the two #2 first vertical tubes by screws. An upper end of the second connecting tube 9 is even with the first horizontal tubes. The configuration of this embodiment facilitates the assembly and disassembly of the pet bed, and the entire structure features three higher sides and a lower central area, which can protect a pet from falling off the pet bed.

The present disclosure has the following advantages.

Through the use of the limiting members in the connection assembly, the assembly of the bed frame may be completed by directly inserting the bottom of the bed frame into the connection assembly, and the bed frame may be disassembled by removing the connection assembly from the bottom of the bed frame. The assembly and disassembly process is simple, so that the assembly efficiency is greatly improved.

In the present disclosure, the terms such as "mount", "connect", "couple", "fix", and variants thereof should be interpreted in a broad sense. For example, "connection" may be a fixed connection, a detachable connection, or an integral connection; and "connection" may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as "inner" and "outer" are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as "an embodiment", "some embodiments", and "specific embodiment" means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A pet bed, comprising:
a bed board;
a bed frame, wherein the bed frame is connected to a lower surface of the bed board; and
a connection assembly, wherein the connection assembly is connected to a bottom of the bed frame.

2. The pet bed according to claim 1, wherein
the bed frame comprises:
two first U-shaped tubes, wherein the two first U-shaped tubes are respectively connected to a first pair of side edges of the bed board; and
two second U-shaped tubes, wherein the two second U-shaped tubes are respectively connected to a second pair of side edges of the bed board, and two ends of each of the two second U-shaped tubes are respectively in contact with end portions of the two first U-shaped tubes on an identical side to the each of the two second U-shaped tubes; or
the bed frame comprises:
two first U-shaped tubes, wherein the two first U-shaped tubes are respectively connected to a pair of side edges of the bed board; and
at least two mounting tubes, wherein the at least two mounting tubes are arranged between the two first U-shaped tubes.

3. The pet bed according to claim 2, wherein
the connection assembly comprises:
limiting members, wherein the limiting members are respectively arranged in two ends of each of the two first U-shaped tubes and penetrate each of the two first U-shaped tubes;
first sleeves, wherein the first sleeves are respectively sleeved over end portions of the two first U-shaped tubes, at least one through hole is provided on each of the first sleeves, and the at least one through hole is arranged opposite to a respective limiting member of the limiting members; and
second sleeves, wherein the second sleeves are respectively sleeved over end portions of the two second U-shaped tubes, and the second sleeves are respectively connected to the first sleeves; or
the connection assembly comprises:
connection members, wherein the connection members are respectively connected to the two first U-shaped tubes and the two second U-shaped tubes; or
connection members, wherein the connection members are respectively connected to the two first U-shaped tubes and the at least two mounting tubes.

4. The pet bed according to claim 3, wherein
an upper end of each of the two first U-shaped tubes is even with an upper end of each of the two second U-shaped tubes.

5. The pet bed according to claim 4, wherein
a first connecting tube is connected to one of the two first U-shaped tubes, and the first connecting tube is even with an upper end of the other of the two first U-shaped tubes.

6. The pet bed according to claim 5, wherein
a second connecting tube is arranged above one of the at least two mounting tubes, and two ends of the second connecting tube are respectively connected to the two first U-shaped tubes.
